(19) United States
(12) Patent Application Publication
(10) Pub. No.: US 2026/0239244 A1
(43) Pub. Date: Aug. 13, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Beijing, Haidian District (CN); Jing Wang, Beijing, Haidian District (CN); Lan Chen, Beijing, Haidian District (CN)

(73) Assignee: NTT DOCOMO, INC., Tokyo (JP)

(21) Appl. No.: 19/156,582

(22) PCT Filed: Feb. 26, 2024
(86) PCT No.: PCT/JP2024/006837

§ 371 Date: Aug. 14, 2025

(30) Foreign Application Priority Data
Feb. 27, 2023 (JP) 2023-028459

(51) Int. Cl. H04W 56/00; H04W 88/06

(52) U.S. Cl. CPC H04W 56/0015; H04W 88/06

(57) ABSTRACT

A terminal according to an aspect of the present disclosure includes a receiving section that receives cell switching indication information in intra-cell or inter-cell mobility supporting a plurality of transmission/reception points (TRPs), and a control section that determines a timing advance (TA) applied to UL transmission, based on the cell switching indication information, wherein the control section determines a reference cell and a reference TRP for deriving the TA, based on whether a TRP of a specific cell is included in a timing advance group (TAG).

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (Non-Patent Literature 1). In addition, for the purpose of further high capacity, advancement and the like of LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

It is assumed that in future radio communication systems (for example, radio communication systems after Rel. 17/5G), communication using a plurality of transmission/reception points (for example, multi-TRP (MTRP)) in a serving cell is controlled, or communication is controlled based on mobility between a plurality of cells including a non-serving cell (inter-cell mobility)/intra-cell mobility (inter-cell mobility).

In this case, it is also assumed that UL transmission is controlled (for example, random access procedure is performed (or timing advance is configured)) for each transmission/reception point or for each serving cell and each non-serving cell. However, how a terminal (user terminal, User Equipment (UE)) controls UL transmission (for example, controlling of the timing advance) with respect to a plurality of transmission/reception points (or non-serving cell) is a problem. When the UL transmission to each transmission/reception point (or the TRP of the serving cell/non-serving cell) is not appropriately controlled, communication quality may be deteriorated.

The present disclosure has been made in view of this respect, and an object of the present disclosure is to provide a terminal, a radio communication method, and a base station capable appropriately performing communication even when intra or inter-cell mobility is performed.

### Solution to Problem

A terminal according to an aspect of the present disclosure includes a receiving section that receives cell switching indication information in intra-cell or inter-cell mobility supporting a plurality of transmission/reception points (TRPs), and a control section that determines a timing advance (TA) applied to UL transmission, based on the cell switching indication information, wherein the control section determines a reference cell and a reference TRP for deriving the TA, based on whether a TRP of a specific cell is included in a timing advance group (TAG).

### Advantageous Effects of Invention

According to an aspect of the present disclosure, communication can be appropriately performed even when intra or inter-cell mobility is performed.

### BRIEF DESCRIPTION OF DRAWINGS

FIGS. 1A to 1D are diagrams to show examples of multi-TRP.

FIGS. 2A and 2B are diagrams to show examples of inter-cell mobility.

FIGS. 3A and 3B are diagrams to show examples of switching between a serving cell and an additional cell by L1/L2 signaling.

FIG. 4 is a diagram to show an example of configuration examples 1 to 3 when candidate cells are supported.

FIGS. 5A to 5C are diagrams to show respective examples of a case where switching candidate cells/candidate cell groups by L1/L2 signaling is performed in configuration examples 1 to 3 when the candidate cells are supported.

FIG. 6 is a diagram to show an example of timing advance groups (TAGs) to which cells included in a cell group belong.

FIG. 7 is a diagram to show an example of a MAC CE for timing advance command.

FIGS. 8A and 8B are diagrams to show examples of a TAG ID configured for the serving cell and the candidate cell.

FIGS. 9A to 9C are diagrams to show examples of applying a reference cell according to a first embodiment.

FIGS. 10A to 10C are diagrams to show examples of applying the reference cell according to the first embodiment.

FIGS. 11A to 11C are diagrams to show examples of applying a reference cell according to a second embodiment.

FIGS. 12A to 12C are diagrams to show examples of applying the reference cell according to the second embodiment.

FIGS. 13A and 13B are diagrams to show examples of applying a reference cell according to a third embodiment.

FIGS. 14A and 14B are diagrams to show examples of applying the reference cell according to the third embodiment.

FIG. 15 is a diagram to show an example of a schematic structure of a radio communication system according to one embodiment.

FIG. 16 is a diagram to show an example of a structure of a base station according to one embodiment.

FIG. 17 is a diagram to show an example of a structure of a user terminal according to one embodiment.

FIG. 18 is a diagram to show an example of a hardware structure of the base station and the user terminal according to one embodiment.

FIG. 19 is a diagram to show an example of a vehicle according to one embodiment.

### DESCRIPTION OF EMBODIMENTS

### TCI, Spatial Relation, QCL

For NR, control of reception processing (for example, at least one of reception, de-mapping, demodulation, and decoding) and transmission processing (for example, at least one of transmission, mapping, precoding, modulation, and coding) of at least one of a signal and a channel (referred to as a signal/channel) in a UE, based on a transmission configuration indication state (TCI state) has been under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may mean that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between the plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

Note that a channel/signal being a target of application of a TCI state may be referred to as a target channel/reference signal (RS) or simply as a target, and another signal described above may be referred to as a reference reference signal (reference RS), a source RS, or simply as a reference.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), a reference signal for QCL detection (also referred to as a QRS), a reference signal for demodulation (DeModulation Reference Signal (DMRS)), and the like.

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCI type X in the TCI state.

### Multi-TRP

For NR, it is studied that one or a plurality of transmission/reception points (TRPs) (multi-TRP) perform DL transmission to a UE by use of one or a plurality of panels (multi-panel). It is also studied that the UE performs UL transmission to the one or plurality of TRPs.

Note that a plurality of TRPs may correspond to the same cell identifier (ID) or different cell IDs. The cell ID may be a physical cell ID (for example, PCI) or a virtual cell ID.

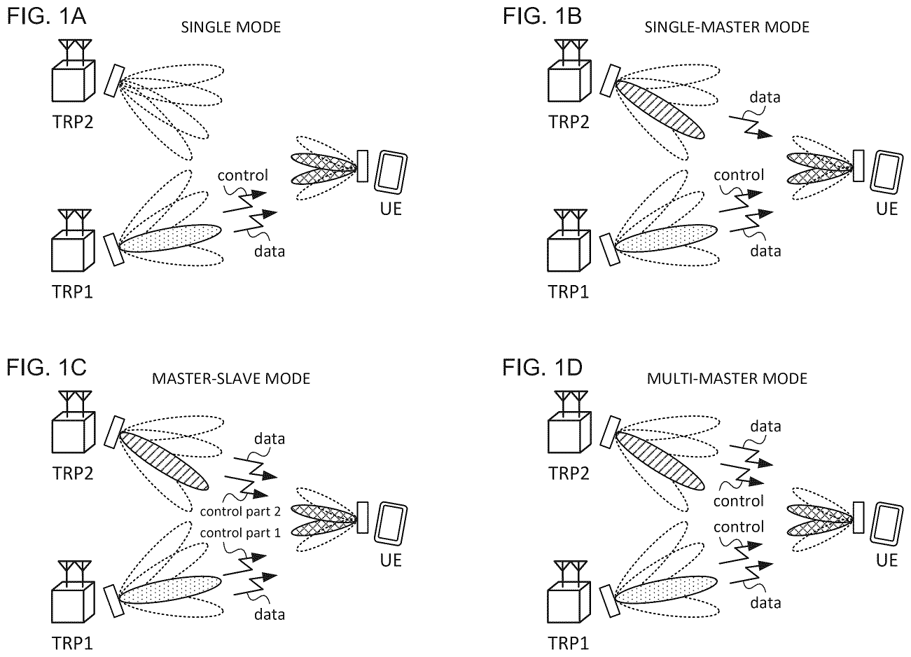

FIGS. 1A to 1D are diagrams to show examples of a multi-TRP scenario. Assume that in these examples, each TRP can transmit four different beams, without limitation.

FIG. 1A shows an example of a case where only one TRP (TRP 1 in this example) of the multi-TRP performs transmission to the UE (which may be referred to as a single mode, a single TRP, or the like). In this case, the TRP 1 transmits both a control signal (PDCCH) and a data signal (PDSCH) to the UE.

In the present disclosure, the single TRP mode may mean a mode for a case where the multi-TRP (mode) is not configured.

FIG. 1B shows an example of a case where only one TRP (TRP 1 in this example) of the multi-TRP transmits a control signal to the UE and the multi-TRP transmits data signals (which may be referred to as a single master mode). The UE receives each PDSCH transmitted from the multi-TRP, based on one downlink control information (DCI).

FIG. 1C shows an example of a case where each in the multi-TRP transmits a part of control signals to the UE and the multi-TRP transmits data signals (which may be referred to as a master slave mode). The TRP 1 may transmit a part 1 of the control signals (DCI) and the TRP 2 may transmit a part 2 of the control signals (DCI). The part 2 of the control signals may depend on the part 1. The UE receives the PDSCH transmitted from the multi-TRP based on these parts of the DCI.

FIG. 1D shows an example of a case where each in the multi-TRP transmits a separate control signal to the UE and the multi-TRP transmits data signals (which may be referred to as a multi-master mode). The TRP 1 may transmit a first control signal (DCI) and the TRP 2 may transmit a second control signal (DCI). The UE receives the PDSCH transmitted from the multi-TRP based on these pieces of DCI.

When a plurality of PDSCHs (which may be referred to as multi-PDSCH (multiple PDSCHs)) from the multi-TRP as shown in FIG. 1B are scheduled by used of one piece of DCI, the DCI may be referred to as single DCI (S-DCI, single PDCCH). When a plurality of PDSCHs from the multi-TRP as shown in FIG. 1D are respectively scheduled by use of a plurality of pieces of DCI, the plurality of pieces of DCI may be referred to as multi-DCI (M-DCI, multi-PDCCH (multiple PDCCHs)).

From each TRP in the multi-TRP, a different transport block (TB)/codeword (Code Word (CW))/different layer may be transmitted. Alternatively, an identical TB/CW/layer may be transmitted from each TRP in the multi-TRP.

As one form of the multi-TRP transmission, non-coherent joint transmission (NCJT) has been studied. In the NCJT, for example, the TRP 1 performs modulation mapping of a first codeword and layer mapping to transmit a first PDSCH using first precoding of a first number of layers (for example, two layers). The TRP 2 performs modulation mapping of a second codeword and layer mapping to transmit a second PDSCH using second precoding of a second number of layers (for example, two layers).

Note that it may be defined that a plurality of PDSCHS (multi-PDSCH) subjected to NCJT partially or completely overlap with respect to at least one of time and frequency domains. In other words, the first PDSCH from the first TRP and the second PDSCH from the second TRP may overlap with respect to at least one of time and frequency resources.

The first PDSCH and the second PDSCH may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

A study is underway to support the PDSCH (transport block (TB) or codeword (CW) repetition across the multi-TRP in a URLLC to the multi-TRP. A study is underway to support a repetition scheme (URLLC scheme, for example, schemes 1, 2a, 2b, 3, and 4) across the multi-TRP on the frequency domain or the layer (spatial) domain or the time domain. In the scheme 1, the multi-PDSCH from the multi-TRP is space-division multiplexed (SDMed). In the schemes 2a and 2b, the PDSCH from the multi-TRP is frequency-division multiplexed (FDMed). In the scheme 2a, a redundancy version (RV) is the same for the multi-TRP. In the scheme 2b, the RV may be the same or different for the multi-TRP. In the schemes 3 and 4, the multi-PDSCH from the multi-TRP is time-division multiplexed (TDMed). In the scheme 3, the multi-PDSCH from the multi-TRP is transmitted in one slot. In the scheme 4, the multi-PDSCH from the multi-TRP is transmitted from different slots.

According to the multi-TRP scenario as described above, flexible transmission control using a good quality channel is possible.

The NCJT using the multi-TRP/panel may be with high rank. Both the single DCI (single PDCCH, for example, FIG. 1B) and the multi-DCI (multi-PDCCH, for example, FIG. 1D) may be supported to support an ideal and non-ideal backhaul between a plurality of TRPs. The maximum number of TRPs may be two for both the single DCI and the multi-DCI.

A study is underway to enhance the ICI for a single PDCCH design (mainly for ideal backhaul). Each TCI codepoint in the DCI may correspond to one or two TCI states. A TCI field size may be the same as that in Rel. 15.

For the PDCCH/CORESET defined in Rel. 15, one TCI state with no CORESET pool index (CORESETPoolIndex) (which may be referred to as TRP information (TRP Info)) is configured in one CORESET.

For PDCCH/CORESET enhancement defined in Rel. 16, the CORESET pool index is configured for each CORESET in the multi-TRP based on the multi-DCI.

### Inter-Cell Mobility

For NR, it is studied that one or a plurality of transmission/reception points (TRPs) (multi-TRP (MTRP)) perform DL transmission to a UE. It is also studied that the UE performs UL transmission to the one or plurality of TRPs.

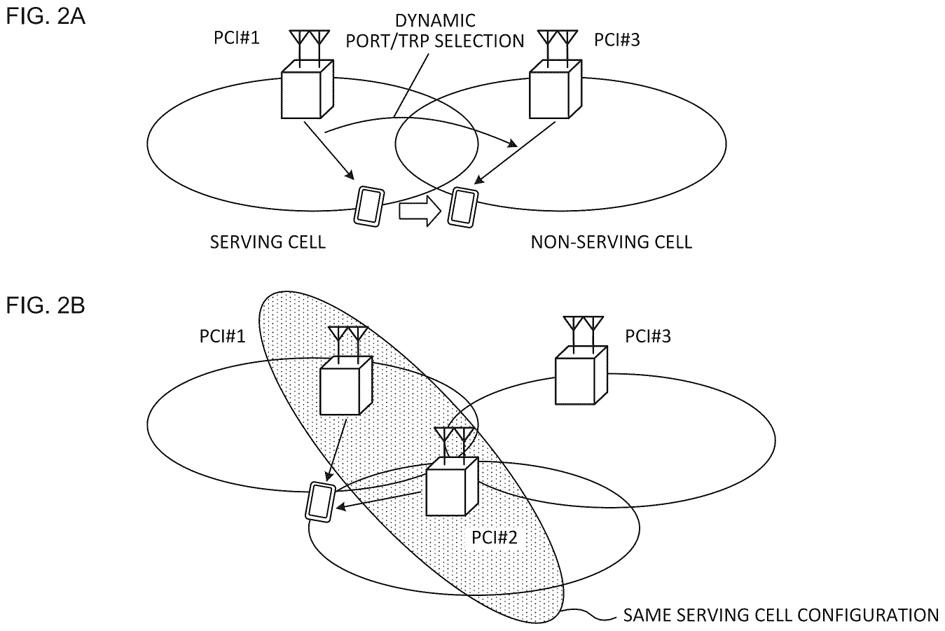

It is considered that a UE receives channels/signals from a plurality of cells/TRPs in inter-cell mobility (for example, L1/L2 inter cell mobility) (see FIGS. 2A and 2B).

FIG. 2A shows an example of inter-cell mobility with cells including a non-serving cell (for example, Single-TRP inter-cell mobility). A UE may be configured with one TRP (or a single TRP) in each cell. Here, shown is a case where the UE receives channels/signals from a base station/TRP of cell #1 being a serving cell, and a base station/TRP of cell #3 being not a serving cell (non-serving cell). For example, this corresponds to a case where the UE switches from cell #1 to cell #3 (for example, fast cell switch).

In this case, selection of a port (for example, an antenna port)/TRP may be performed dynamically. The selection of a port (for example, an antenna port)/TRP may be performed based on a TCI state indicated or updated by DCI/MAC CE. Here, shown is a case of supporting configuration of different physical cell IDs (for example, PCIs) for cell #1 and cell #3.

FIG. 2B shows an example of the multi-TRP scenario (for example, inter-cell mobility in a case of using the multi-TRP (Multi-TRP inter-cell mobility)). A UE may be configured with a plurality of (for example, two) TRPs (or different CORESET pool indices) in each cell. Here, shown is a case where the UE receives channels/signals from TRP #1 and TRP 2. Here, also shown is a case where TRP #1 corresponds to physical cell ID (PCI) #1 and TRP #2 corresponds to PCI #2.

The multi-TRP (for example, TRPs #1 and #2) may be connected via ideal/non-ideal backhaul to exchange information, data, and the like. Each TRP of the multi-TRP may transmit the same or a different codeword (Code Word (CW)) and the same or a different layer. As one form of the multi-TRP transmission, non-coherent joint transmission (NCJT) may be employed as shown in FIG. 2B. Here, shown is a case where NCJT is performed between TRPS corresponding to different PCIs. Note that the same serving cell configuration may be applied/configured for TRP #1 and TRP #2.

It may be defined that a plurality of PDSCHs (multi-PDSCH) subjected to NCJT partially or completely overlap with respect to at least one of time and frequency domains. In other words, a first PDSCH from TRP #1 and a second PDSCH from TRP #2 may overlap in terms of at least one of time and frequency resources. The first PDSCH and the second PDSCH may be used for transmission of the same TB or may be used for transmission of different TBs.

The first PDSCH and the second PDSCH may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

A plurality of PDSCHs (which may be referred to as multi PDSCH (multiple PDSCHs)) from the multi-TRP may be scheduled by using one piece of DCI (single DCI (S-DCI, single PDCCH)) (single-master mode). The one piece of DCI may be transmitted from one TRP of the multi-TRP. A structure using one piece of DCI in multi-TRP may be referred to as single-DCI based multi-TRP (mTRP/MTRP).

The plurality of PDSCHs from the multi-TRP may be scheduled by using a plurality of respective pieces of DCI (multi-DCI (M-DCI), multi-PDCCH (multiple PDCCHs)). The plurality of pieces of DCI may be transmitted from respective TRPs of the multi-TRP. A structure using a plurality of pieces of DCI in multi-TRP may be referred to as multi-DCI based multi-TRP (mTRP/MTRP).

The UE may assume to transmit, to the different TRPs, separate CSI reports related to the respective TRPs. Such CSI feedback may be referred to as separate feedback, separate CSI feedback, and the like. In the present disclosure, “separate” may be interchangeably interpreted as “independent.”

In the inter-cell mobility, a scenario 1 or a scenario 2 below are contemplated. Note that in the present disclosure, a serving cell may be interchangeably interpreted as a TRP in the serving cell. Layer 1/layer 2 (L1/L2) and DCI/Medium Access Control Control Element (MAC CE) may be interchangeably interpreted. In the present disclosure, a physical cell ID (Physical Cell Identity (PCI)) different from the PCI of the current serving cell may be described simply as a “different PCI”. A non-serving cell, a cell having a different PCI, a candidate cell, and an additional cell may be interchangeably interpreted.

### Scenario 1

The scenario 1 corresponds to, for example, the inter-cell mobility for the multi-TRP. Note that the scenario 1 may be a scenario not corresponding to the inter-cell mobility for the multi-TRP. In the scenario 1, for example, a procedure below is performed.
(1) The UE receives from the serving cell a configuration required for using a radio resource for data transmission/reception that includes an SSB configuration for beam measurement of a TRP corresponding to a PCI different from that of the serving cell, and a resource for the different PCI.
(2) The UE performs beam measurement of a TRP corresponding to the different PCI, and reports a beam measurement result to the serving cell.
(3) Based on the above reporting, a transmission configuration indication (TCI) state associated with the TRP corresponding to the different PCI is activated through L1/L2 signaling from the serving cell.
(4) The UE transmits/receives using a UE-dedicated channel on the TRP corresponding to the different PCI.
(5) The UE needs to always cover the serving cell including also the case of the multi-TRP. The UE needs to use a common channel from the serving cell (broadcast control channel (BCCH), paging channel (PCH) or the like, similarly to the system of related art.

In the scenario 1, when the UE transmits/receives a signal to/from the additional cell/TRP (the TRP corresponding to the PCI of the additional cell), the serving cell (serving cell assumption in the UE) is not changed. Specifically, serving cell switching by L1/L2 is not supported. The UE is configured with a higher layer parameter related to a PCI of the non-serving cell from the serving cell. The scenario 1 may be applied in Rel. 17, for example.

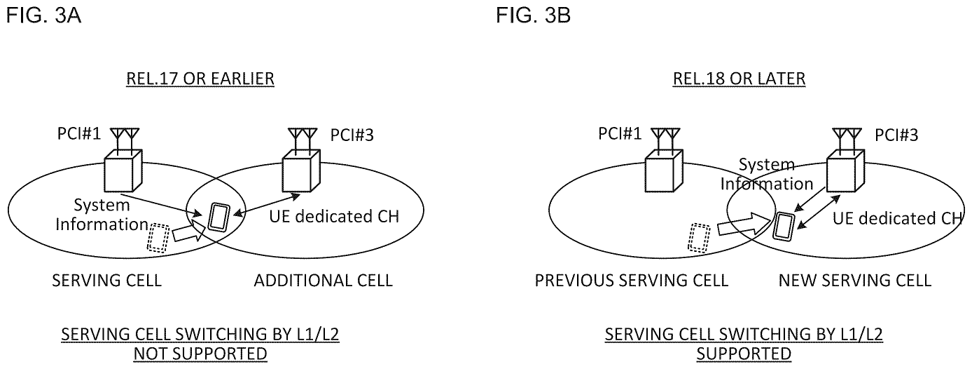

FIG. 3A is a diagram to show an example of UE migration in Rel. 17. Assume a case where the UE moves from a cell (serving cell) with PCI #1 to a cell (additional cell) (overlapping the serving cell) with PCI #3. In this case, the serving cell switching by L1/L2 is not supported in Rel. 17.

The additional cell is a cell having an additional PCI different from the PCI of the serving cell. The UE can receive/transmit the UE-dedicated channel from/to the additional cell. The UE needs to be within a coverage of the serving cell in order to receive a UE common channel (for example, system information/paging/short message). When the UE moves out of the coverage of the serving cell, cell switching by handover (also referred to as L3 mobility) or the like is required.

### Scenario 2

In the scenario 2, L1/L2 inter-cell mobility is applied. In the L1/L2 inter-cell mobility, serving cell change can be performed using a function such as beam control without RRC reconfiguration. In other words, transmitting/receiving to and from the additional cell can be performed without handover (or without performing an L3 mobility procedure). Applying the L1/L2 inter-cell mobility not requiring handover allows data communication to continue even upon the serving cell change because a period incapable of the data communication occurs due to the handover in which RRC reconnection is required and so on. In the scenario 2, for example, a procedure below is performed.
(1) The UE receives from serving cell an SSB configuration of a cell (additional cell) with the different PCI for the beam measurement/serving cell change.
(2) The UE performs beam measurement of a cell using the different PCI, and reports a measurement result to the serving cell.
(3) The UE may receive a configuration of the cell with the different PCI (serving cell configuration) through higher layer signaling (for example, RRC). Specifically, a pre-configuration related to the serving cell change may be performed. This configuration may be performed together with or separately from the configuration in (1).
(4) Based on the above reporting, a TCI state of the cell with the different PCI may be activated by L1/L2 signaling according to the serving cell change. The TCI state activation and the serving cell change may be separately performed.
(5) The UE changes the serving cell (serving cell assumption), and starts receiving/transmitting using the pre-configured UE-dedicated channel and the TCI state.

Specifically, in the scenario 2, the serving cell (serving cell assumption in the UE) is updated by L1/L2 signaling. The scenario 2 may be applied in Rel. 18 or later versions.

FIG. 3B is a diagram to show an example of UE migration in Rel. 18. In Rel. 18, THE serving cell is switched by L1/L2. The UE can receive/transmit the UE-dedicated channel/common channel from/to the new serving cell. The UE may be out of the coverage of the previous serving cell.

### Configuration of Candidate Cell

In the L1/L2 inter-cell mobility, besides the serving cell, a candidate cell may be configured. In the present disclosure, the candidate cell may be interchangeably interpreted as a target cell, an additional cell, and an additional PCI. One or more candidate cells (or candidate cell group) may be separately associated with each serving cell, or one or more candidate cells (or candidate cell group) may be associated with a plurality of serving cells in common.

A configuration of the candidate cell (or candidate cell group) may be configured using a certain higher layer parameter (for example, ServingCellConfig) similarly to the inter-cell beam management (inter-cell BM) for the existing systems (for example, Rel. 17 or previous versions). Alternatively, for the configuration of the candidate cell (or candidate cell group), a framework for carrier aggregation configuration (for example, CA configuration framework) or a framework for CHO (Conditional Handover)/CPC (Conditional PSCell Change) configuration may be reused.

For the candidate cell configured in the higher layer parameter (or candidate cell group), activation/deactivation may be indicated to the UE by the MAC CE/DCI.

As the configuration of the candidate cell (or association with the serving cell), for example, at least one of configuration example 1 to configuration example 3 below may be applied. Here, SpCell #0, SCell #1, and SCell #2 are configured as the serving cell, and an example of the candidate cell/candidate cell group configured separately from the serving cell is shown. The following configuration example 1 to configuration example 3 are merely examples, and the number of serving cells/the number of candidate cells/the number of candidate cell groups, association between the serving cell and the candidate cell, and the like may be adequately changed without limitation. Alternatively, another configuration example(s) may be supported/employed in addition to/instead of configuration example 1 to configuration example 3.

### Configuration Example 1

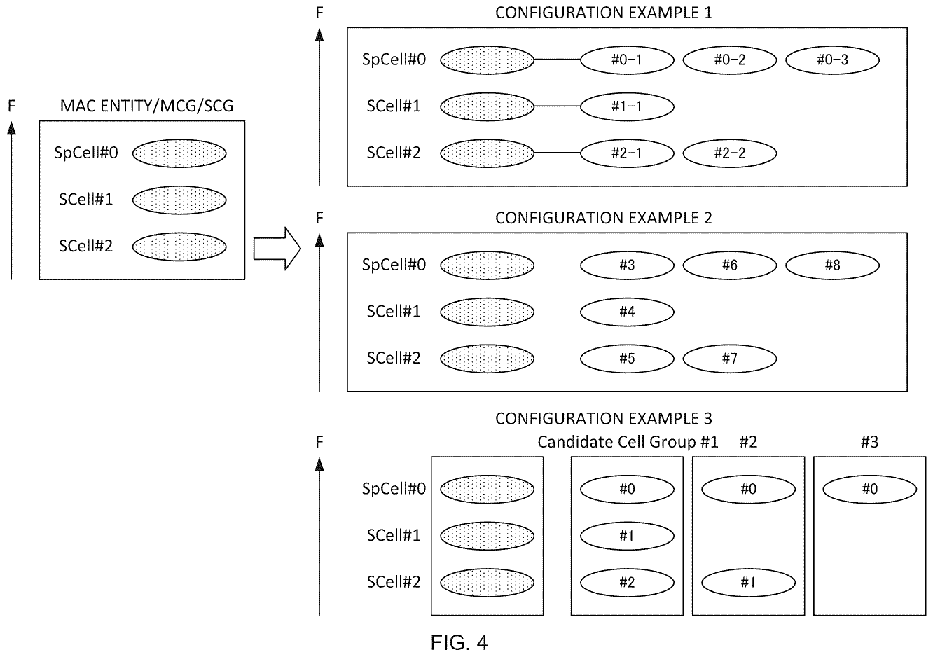

In configuration example 1, one or more candidate cells are associated with/configured for each serving cell (or a frequency domain corresponding to each serving cell) (see FIG. 4). Here, a case is shown where candidate cells #0-1, #0-2, and #0-3 are associated with SpCell #0 (or a frequency domain corresponding to SpCell #0), candidate cell #1-1 is associated with SCell #1 (or a frequency domain corresponding to SCell #1), and candidate cells #2-1 and #2-2 are associated with SCell #2 (or a frequency domain corresponding to SpCell #2). Information related to this association may be configured for/indicated to a UE by a base station by RRC/MAC CE/DCI.

### Configuration Example 2

In configuration example 2, candidate cells are associated with/configured for a MAC entity/MCG/SCG (see FIG. 4). Here, a case is shown where candidate cells #3 to #8 are associated with the MAC entity/MCG/SCG. In this case, instead of a candidate cell(s) being associated with each serving cell, the candidate cells are configured for the MAC entity or cell group (for example, an MCG/SCG). Information related to a candidate cell(s) to be configured for each cell may be configured for/indicated to a UE by a base station by RRC/MAC CE/DCI.

### Configuration Example 3

In configuration example 3, one or more candidate cell groups are configured (see FIG. 4). Each candidate cell group includes one or more candidate cells. Here, a case is shown where candidate cell group #1 including candidate cells #0 to #2, candidate cell group #2 including candidate cells #0 and #1, and candidate cell group #3 including candidate cell #0 are configured. At least one of information related to the configured candidate cell groups and information related to the candidate cells included in each candidate cell group may be configured for/indicated to the UE by the RRC/MAC CE/DCI from the base station.

### Serving Cell Switching

In existing systems (for example, Rel. 17), L1 beam indication related to a TCI state of an additional PCI (or an additional cell) (for example, indication by a ICI state field of the DCI) is supported.

It is assumed, in Rel. 18 or later versions, that a new L1/L2 signal (for example, DCI/MAC CE) indicating switching of a serving cell (for example, serving cell switch) is supported. It may be assumed that, as the indication, at least one of implicit indication and explicit indication is supported. The implicit indication may mean that a certain CORESET is updated to a ICI state associated with an additional PCI by a MAC CE, for example. The explicit indication may mean that cell switching is directly indicated by DCI/MAC CE.

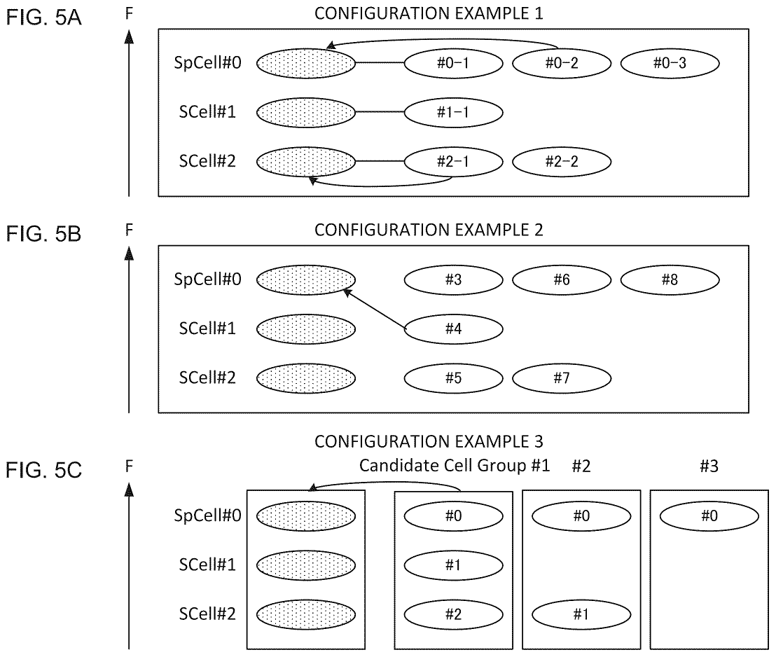

For example, in configuration example 1 of candidate cells, a certain candidate cell may be specified as a serving cell (or indicated for switching with a serving cell) via L1/L2 signaling. FIG. 5A shows a case where candidate cell #0-2 turns to be an SpCell of the MCG/SCG (SpCell #0 and candidate cell #0-2 are switched) by L1/L2 signaling. Also shown is a case where candidate cell #2-1 turns to be an SCell of an MCG/SCG (SCell #2 and candidate cell #2-1 are switched) by L1/L2 signaling.

Alternatively, in configuration example 2 of candidate cells, a certain candidate cell may be specified as a serving cell (or indicated for switching with a serving cell) via L1/L2 signaling. FIG. 5B shows a case where candidate cell #4 turns to be an SpCell of an MCG/SCG (SpCell #0 and candidate cell #4 are switched) by L1/L2 signaling.

Alternatively, in configuration example 3 of candidate cells, a certain candidate cell group for one or more candidate cells included in the certain candidate cell group) may be changed/updated to a serving cell group via L1/L2 signaling. FIG. 5C shows a case where candidate cell group #1 (or candidate cells #0 to #2 included in candidate cell group #1) turns to be a serving cell group (or the serving cell group and candidate cell group #1 are switched) by L1/L2 signaling. Among the candidate cells (here, candidate cells #0 to #2) included in candidate cell group #1, a candidate cell associated with SpCell #0 or a candidate cell configured in same the frequency domain as SpCell #0 (here, candidate cell #0) may be configured for a new SpCell. Alternatively, a candidate cell to turn to be an SpCell may be indicated by L1/L2 signaling.

### Timing Advance Group

When a plurality of TRPs are used, there are some cases where the distance between a UE and each TRP is different. The plurality of TRPs may be included in the same cell (for example, a serving cell). Alternatively, among the plurality of TRPs, a certain TRP corresponds to the serving cell, while the other TRP(s) may correspond to a non-serving cell(s). In this case, it is also assumed that the distance between each TRP and the UE is different.

In existing systems, transmission timing of a UL (Uplink) channel and/or a UL signal (UL channel/signal) is adjusted by timing advance (TA). Reception timing of a UL channel/signal from a different user terminal (UE) is adjusted on the radio base station (also referred to as a TRP (Transmission and Reception Point), qNB (gNodeB), and the like)) side.

A UE may employ timing advance for each timing advance group (TAG) (multiple timing advances) configured in advance to perform timing control for UL transmission.

When the multiple timing advances is employed, timing advance groups (TAGs) classified according to transmission timing are supported. The UE may control UL transmission timing in each TAG by assuming that the same TA offset (or TA value) is used for each TAG. In other words, the TA offset may be configured independently for each TAG.

When the multiple timing advances are employed, the UE independently adjusting transmission timing for the cells belonging to each TAG enables matching at a radio base station in terms of timing of uplink signal reception from the UE even when a plurality of cells are used.

A TAG (for example, serving cells belonging to the same TAG) may be configured by a higher layer parameter. The same timing advance value may be applied to the serving cells belonging to the same TAG. A timing advance group including an SpCell of a MAC entity may be referred to as a primary timing advance group (PTAG), and a TAG other than the PTAG may be referred to as a secondary timing advance group (STAG).

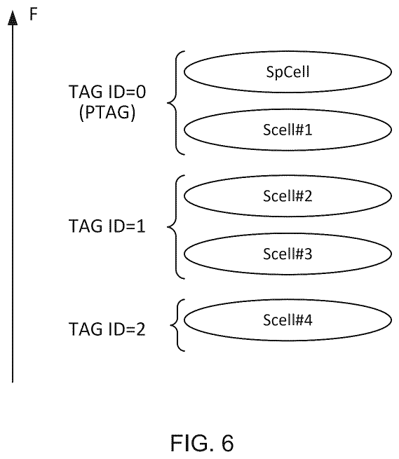

In existing systems (for example, Rel-16 NR), configuration of four TAGs at maximum (for example, MCG/SCG) is supported for each cell group (see FIG. 6). FIG. 6 shows a case where three TAGS are configured for a cell group including an SpCell and SCells #1 to #4. Here, shown is a case where the SpCell and SCell #1 belong to a first TAG (PTAG or TAG #0), SCell #2 and SCell #3 belong to a second TAG (TAG #1), and SCell #4 belongs to a third TAG (TAG #2).

A UE may be notified of a timing advance command (TA command) by using a MAC control element (for example, a MAC CE). The TA command is a command that indicates an uplink channel transmission timing value and is included in the MAC control element. The TA. command is signaled from a radio base station to the UE on a MAC layer. The UE controls a certain timer (for example, a TA timer), based on reception of the TA command.

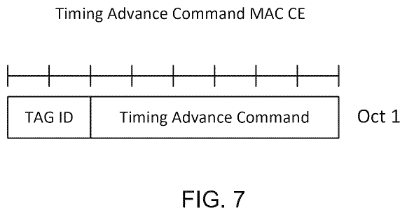

A timing advance command MAC CE (TAC MAC CE) may have a structure including a field for timing advance group index (for example, TAG ID) and a field for timing advance command (see FIG. 7).

On the other hand, a case is assumed that, in future radio communication systems, a different TAG (or TAG-ID) is configured for each of one or more TRPs corresponding to a certain cell (or CC). for example, for a multi-TRP operation using the multi-DCI, two TAs (or TAG) is assumed to be supported for the UL transmission.

Alternatively, a case is assumed that different TRPs corresponding to a certain cell share a common TAG. Alternatively, a case where the TA command MAC CE is applied only to one TRP, or a case where the TA command MAC CE is applied to a plurality of TRPs is assumed.

Alternatively, a case is also assumed that different TRPs corresponding to different cells use different TAG/share a common TAG. For example, it is also assumed that, UL transmission is controlled based on common/different timing advance for a serving cell (or a TRP of the serving cell) and a non-serving cell (or a TRP of the non-serving cell) in the inter-cell mobility.

As described above, it is assumed that in the MIMO in Rel. 18 or later versions, two timing advances (TA) for two TRPs are supported in the multi-TRP operation using the multi-DCI.

When the TAG is configured/controlled per TRP, a time alignment timer (for example, timeAlignmentTimer) may be configured on a per-TRP basis. The time alignment timer may control a time for which the MAC entity considers the serving cell belonging to the associated TAG to be uplink time adjusted (for example, uplink time aligned). For example, the time alignment timer may be configured by RRC to maintain (for example, perform maintenance of) the UL time alignment.

The time alignment timer (for example, timeAlignementTimer) may be maintained for the UL time alignment. In Rel. 17, the time alignment timer (for example, timeAlignementTimer) correspond to each TAG. When the UE has received a MAC CE for timing advance command (for example, a TAC MAC CE), the UE starts or restarts a time alignment timer related to each indicated timing advance group (for example, TAG).

When a MAC entity receives the TAC MAC CE, and a certain value (N_{TA}) is maintained for the indicated TAG, the MAC entity uses the timing advance command for the indicated TAG or starts or restarts the time alignment timer related to the indicated TAG. The certain value (N_{TA}) may be timing advance between DL and UL.

Operation when the time alignment timer expires may be defined separately for a PTAG and an STAG. Note that a timing advance group (TAG) including an SpCell of a MAC entity may be referred to as a primary timing advance group (PTAG), and a TAG other than the PTAG may be referred to as a secondary timing advance group (STAG).

For example, Rel. 17 supports that a certain PTAG operation is applied when a timing advance timer corresponding to the PTAG expires, and a certain STAG operation may be applied when a timing advance timer corresponding to the STAG expires.

For example, when the time alignment timer expires, the following operation (for example, the certain PTAG operation/certain STAG operation) may be performed.

### Certain PTAG Operation

In a case where the time alignment timer is associated with a PTAG,
flush (discard) all the HARQ buffers of all serving cells.
notify RRC of release of a PUCCH, if configured, for all the serving cells.
notify RRC of release of an SRS, if configured.
clear all configured DL assignments and configured UL assignments.
clear a PUSCH resource for semi-persistent CSI reporting.
Cause all running time alignment timers to expire.
maintain N_{TA} of all TAGS.

### Certain STAG Operation

In a case where the time alignment timer is associated with an STAG, for all serving cells belonging to the TAG,
flush (discard) all HARQ buffers.
notify RRC of release of a PUCCH, if configured.
notify RRC of release of an SRS, if configured.
clear all configured DL assignments and UL assignments.
clear a PUSCH resource for semi-persistent CSI reporting.
maintain N_{TA} of the TAG.

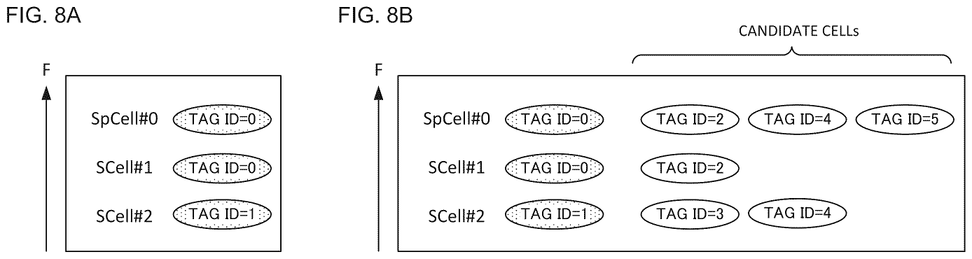

When the candidate cell is configured/defined, it may be supported to control communication in consideration of a timing advance (TA) corresponding to each candidate cell. For example, as described above, each candidate cell may be associated with the TAG (see FIGS. 8A and 8B). FIG. 8A show an example of the TAG (or TAG ID configuration) per cell group in the existing systems (for example, Rel. 17 or previous versions), and FIG. 8B shows an example of the TAG ID configuration for each candidate cell.

When the candidate cell is configured/defined, it is assumed that different serving cells/different candidate cells are associated with the same TAG, as shown in FIG. 8B. The TAG of the candidate cells may be indicated from the base station, or determined based on the TA of the candidate cell acquired by the UE.

It is contemplated that the UE performs the UL transmission in consideration of the TA corresponding to the candidate cell regarding the UL transmission of the candidate cell (for example, the candidate cell to which switching to the serving cell is indicated). When the TA of the candidate cell is considered, the UE needs to perform acquiring the TA of the candidate cell (for example, TA acquisition of candidate cells).

For the TA acquisition of candidate cells, a plurality of TA acquisition methods are contemplated such as TA acquisition using the RACH (for example, RACH-based solutions) and TA acquisition not using the RACH (RACH-less solutions). The TA acquisition method may be interchangeably interpreted as a TA acquisition scheme, a TA acquisition type, or a TA acquisition procedure. In the present disclosure, TA acquisition, TA measurement, TA calculation, TA computation, and TA determination may be interchangeably interpreted.

For example, the UE may acquire the TA of the candidate cell by transmitting an RACH indicated/triggered by a PDCCH (for example, PDCCH order RACH) to the candidate cell. Information related to the TA of the candidate cell (for example, TA value) may be included in an RACH response signal (for example, RAR). The RAR may be transmitted from the serving cell or the candidate cell. Alternatively, the TA of the candidate cell may be acquired by use of an RACH triggered by the UE, or an RACH triggered in the higher layer from the network. The PDCCH order may be triggered only by a source cell (or serving cell).

Alternatively, the UE may acquire the TA of the candidate cell by transmitting a signal other than the RACH to the candidate cell. The information related to the TA of the candidate cell (for example, TA value) may be indicated to the UE from the base station. The SRS may be applied as the signal other than the RACH, for example.

Alternatively, the UE may measure/calculate/acquire the TA for the candidate cell based on a DL signal (for example, downlink reference signal) transmitted from each cell (for example, candidate cell/serving cell). The method for the UE to acquire the TA for the candidate cell based on the DL signal transmitted from one or more cells may be referred to as UE based TA measurement.

In the UE based TA measurement, a downlink reference signal may be a certain DL signal (for example, synchronization signal block (for example, SSB)/CSI-RS, and the like). For example, the UE may measure a difference between reception timings of DL signals from a plurality of cell (or two cells) to acquire the TA of the candidate cell.

The plurality of cells may include a cell as a reference (for example, serving cell). In this case, the UE may calculate the TA required for the candidate cell based on a reception timing for the reference cell (and the TA value of the reference cell), and the timing difference (for example, T) between the reference cell and the candidate cell. The UE may use a timing advance command (TAC) transmitted from the serving cell to acquire the TA of the candidate cell.

### TA Control on Per-TRP/Panel Basis

As described above, when performing communication using a plurality of transmission/reception points (for example, TRP)/panel, controlling the timing advance (TA) per TRP/per panel is assumed,

In NR in Rel. 18 or later versions, it is contemplated that a contention based random access (CBRA)/non-contention based random access (Contention Free Random Access (CFRA)) are considered/determined on the per-TRP basis or per TRP TA (TA per TRP) for the RACH triggered by the PDCCH order and the RACH triggered by the UE.

When timing advance application/configuration is supported per TRP (or on the per-TRP basis), the UE controls UL transmission (for example, RACH transmission and the like) in each TRP based on the timing advance corresponding to each TRP (or the timing advance group to which each TRP belongs).

Information related to the TRP corresponding to each serving cell (for example, TRP index/TRP ID) may be configured for/indicated to the UE from the base station using RRC/MAC CE/downlink control information. The UE may receive relevant information related to the timing advance corresponding to each TRP (for example, information related to TA value/timing advance command/time alignment timer and the like) from the base station.

The embodiments in the present disclosure may be applied/supported in at least one of intra-cell multi-TRP (Intra-cell M-TRP) and inter-cell multi-TRP (Inter-cell M-TRP).

In the intra-cell multi-TRP, a plurality of TRPs (or activated ICI states of a plurality of TRPs) may be associated with the same cell ID. The cell ID may be a physical cell ID (PCI).

In the inter-cell multi-TRP, a plurality of TRPs (or activated TCI states of a plurality of TRPs) may be associated with different cell IDs (for example, PCI). For example, in the inter-cell multi-TRP, two TRPs may be interchangeably interpreted as two TRPs respectively associated with two PCIs.

When timing advance application/configuration is supported per TRP (or on the per-TRP basis), each TRP may belong a different TAG. A plurality of TRPs (for example, two TRPs) in the serving cell may respectively belong to two TAGS. The TAG may include a plurality of TRPs from a plurality of serving cells. All the TRPs/serving cells in the TAG apply/maintain the same timing advance (TA)/same time alignment timer.

In the present disclosure, the TAG may include one or more sub-TAG. For example, two TRPs in the serving cell may belong to two sub-TAGs respectively and one TAG. The sub-TAG may include a plurality of TRPs from a plurality of serving cells. All the TRPs/serving cells in the sub-TAG apply/maintain the same timing advance (TA)/same time alignment timer.

For example, the TA may be applied per TRP (or indication per TRP TA may be performed). For example, at least one of options below may be applied.

### Option 1

The TAG-IDs different per TRP may be configured, and the TA command MAC CEs different per TRP may be configured. Each TAG may maintain the time alignment timer for UL time alignment.

### Option 2

Different TRPs may share a TAG. The TA command MAC CE may be applied to only one TRP. The UE applies a different TA to another TRP. For example, the UE may adjust a TA value for another TRP (for example, TRP #1) by the TA offset (TA_TRP_offset) based on a TA for TRP #0 (TA_TRP #0).

In this case, only one time alignment timer may be present for UL time alignments of a plurality of TRPs. This may mean the UL time alignments of the plurality of TRPs are simultaneously maintained or lost.

### Option 3

One TAG may be configured. The TA command MAC CE may be applied to a plurality of serving TRPs for the UE.

### Option 4

One TAG may be configured. The TA command MAC CE received in a TRP/CW/PDSCH/DMRS port group may be applied to the TRP/CW/PDSCH/DMRS port group of the TAG. Each TRP/CW/PDSCH/DMRS port group of the TAG maintains the time alignment timer for UL time alignment.

As described above, in Rel. 18 or later versions, it is also assumed that a plurality of timing advances are supported in the multi-TRP (for example, the multi-TRP using the multi-DCI), For example, a plurality of (for example, two) timing advances may be supported the multi-TRP (for example, two TRPS) using the multi-DCI. Applying a plurality of timing advances to the multi-TRP may be supported in an intra-cell/inter-cell multi-DCI multi-TRP Scenario, or a plurality of frequency ranges for example, FR1 and FR2).

### Association between TA and Candidate Cell

In the TA in the L1/L2 inter-cell mobility, in order to acquire the TA of the candidate cell before receiving a cell switching command (L1/L2 signal (for example, DCI/MAC CE)), at least the following TA/TAG association with the candidate cell is under study.
Alt 1: the TA/TAG and the candidate cell are implicitly associated with each other. For example, association between the TA/TAG and the TCI state may be configured.
Alt 2: the TA/TAG and the candidate cell are explicitly associated with each other. For example, the TA/TAG and the SSB(s)/TRS(s) may be associated with each other. The association may be provided as a part of the configuration of the candidate cell.

### UE Transmission Timing

The UE may have a capability to follow a frame timing change of the reference cell in a connected state. The UL fame transmission of the UE may be performed at a certain TA (Timing Advance) before the corresponding DL reception from the reference cell. Here, the certain TA may be derived by (N_{TA}+N_{TA offset})×T_{C}. N_{TA} may represent a certain value for the TA, N_{TA offset}) may represent an offset for the certain value and T_{C} may represent a reference time unit.

In the serving cell in the PTAG, the UE uses the SpCell as the reference cell to derive the UE transmission timing for the cell in the PTAG. On the other hand, in the serving cell in the STAG, the UE uses any of a plurality of activated SCells as the reference cell to derive UE transmission timing for the cell in the STAG. UE initial transmission timing accuracy and gradual timing adjustment requirements may be defined in the specifications.

In the present disclosure, the “reference cell” may mean a “reference cell” in “the UL fame transmission takes place at an TA (Timing Advance) before the corresponding DL reception from the reference cell (the first detected path in time)”. In addition, the “reference TRP” may mean a “reference TRP” in “the UL fame transmission takes place at an TA (Timing Advance) before the corresponding DL reception from the reference TRP (the first detected path in time)”. That is, the cell and the TRP may be interchangeably interpreted.

As described above, the UE uses the reference cell/reference TRP to derive the UE transmission timing (that is, TA) for the cell/TRP in the TAG.

### Intra-Cell Mobility

In Rel. 18 or later versions, it is assumed that a configuration of the TA per TRP is supported for the multi-DCI based multi-TRP (for example, mDCI MTRP). Both the intra-cell and inter-cell multi-TRP may be supported. For example, for a multi-DCI based multi-TRP operation with a plurality of (for example, two) TAs being supported, configurations of two timing advance groups (TAGs) belonging to the serving cell are supported.

In the L1/L2 inter-cell mobility, a different TAG may be configured for the serving cell/candidate cell.

In the L1/L2 inter-cell mobility, at least one of the intra-cell multi-TRP (for example, a case where two TRPs shares the same PCI) and the inter-cell multi-TRP (for example, a case where two TRPs have different PCIs (similar to Rel-17/18 multi-DCI based multi-TRP)) may be supported.

Information related to the serving cell/candidate cell configured with the multi-TRP may be configured for/indicated to the UE from the base station using the higher layer parameter/MAC CE/DCI and the like.

In the case of the intra-cell multi-TRP, two TRPs for each cell may respectively correspond to two TCI states associated with one PCI. In the case of the inter-cell multi-TRP, two TRPs corresponding to the different cells may respectively correspond to two TCI states respectively associated with two PCIs.

For the L1/L2 inter-cell mobility, whether the intra-cell multi-TRP and the inter-cell multi-TRP are supported/configured, synchronization/asynchronization configuration may be defined.

### Analysis

As described above, for the inter-cell mobility, the existing specifications assume that the SpCell/SCell that is the serving cell is used as the reference cell/reference TRP upon deriving the TA for the UE transmission. Specifically, the existing UE operation targets only the serving cell for the TA derivation. On the other hand, in future specifications, a study is underway to use the non-serving cell (non-serving cell)/candidate cell besides the serving cell as the reference cell. Specifically, a study is underway to enhance the existing UE operation for the TA derivation toward the non-serving cell/candidate cell.

However, whether the non-serving cell can be used as the reference cell is not clarified. To be more specific, whether the non-serving cell not associated with the activated TCI state can be used as the reference cell in the L1/L2 inter-cell mobility needs to be clarified.

In the existing UE operation, the UE uses the activated SCell as the reference cell in the STAG as described above. However, in the L1/L2 inter-cell mobility, there may be a case where the activated SCell is not present in the STAG. For example, there may be a case where the serving cell is present but only a deactive SCell is present, and a case where the serving cell is not present but only the non-serving cell is present as the candidate cell. Specifically, when no active SCell is present in the STAG, which cell the UE uses as the reference cell is not clear.

For the intra-cell/inter-cell multi-TRP, there may be a case where, for example, when two TRPs (two CORESETPoolIndex) are configured for a certain cell, one TRP of these two TRPs is currently not associated with any active TCI state. In this case, whether the TRP not associated with any active TCI state can be used as the reference TRP for the TA derivation is not clear.

As described above, in the intra-cell/inter-cell mobility, if the reference cell/reference TRP for the TA derivation is not clear, the UE may not appropriately control the TA, deterioration the communication quality.

Therefore, the inventors of the present invention focused on the case of the non-serving cell/candidate cell regarding the applying of the reference cell for the TA derivation, and came up with an aspect of the present embodiments.

Embodiments according to the present disclosure will be described in detail with reference to the drawings as follows. The radio communication methods according to respective embodiments may each be employed individually, or may be employed in combination.

### Interchangeable Interpretation and So On

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and other messages (for example, positioning (for example, messages from the core network such as NR Positioning Protocol A (NRPPa)/LTE Positioning Protocol (LPP)) message).

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the following embodiments, a “plurality of” and “two” may be interchangeably interpreted. A “TAG” and a “TAG ID” may be interchangeably interpreted. A “cell,” a “CC,” and a “carrier” may be interchangeably interpreted. In the following embodiments, “calculation,” “computation,” and “acquisition” may be interchangeably interpreted.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the present disclosure, TRP, CORESET pool index (CORESETPoolIndex), TRP ID, ID for TRP, TAG ID, TCI state group, spatial relation group, QCL source RS group, DL RS group, pathloss RS group, and PCI (for inter-cell multi-TRP) may be interchangeably interpreted.

In the present disclosure, being associated with different TRP, being associated with different CORESET pool index (CORESETPoolIndex), being associated with different TRP ID, being associated with different TRP ID, being associated with different TAG ID, being associated with different TCI state group, being associated with different spatial relation group, being associated with different QCL source RS group, being associated with different DL RS group, being associated with different pathloss RS group, and being associated with different PCI (for inter-cell multi-TRP) may be interchangeably interpreted

The embodiments in the present disclosure may be applied to at least one of the intra-cell multi-TRP and the inter-cell multi-TRP.

In the present disclosure, the intra-cell multi-TRP may mean that the activated TCI states of a plurality of (for example, two) TRPs are associated with the same PCI.

In the present disclosure, the inter-cell multi-TRP may mean that the activated TCI states of a plurality of (for example, two) TRPs are associated with different PCIs.

In the present disclosure, in the case of the inter-cell multi-TRP, a plurality of (for example, two) TRPs may mean a plurality of (for example, two) TRPs associated with a plurality of (for example, two) PCIs.

In the present disclosure, a non-serving cell, an additional cell, a candidate cell, and a target cell may be interchangeably interpreted.

In the present disclosure, a reference cell may be interchangeably interpreted as a reference cell, a specific cell, or a reference cell. The reference cell may be, for example, a specific cell, or a cell for which the TA value is indicated/acquired. The reference cell may be defined in the specifications, or configured for/indicated to the UE by the RRC/MAC CE/DCI from the base station.

In the present disclosure, a reference TRP may be interchangeably interpreted as a reference TRP, a specific TRP, or a reference TRP.

In the present disclosure, a cell switching command (L1/L2 signal (for example, DCI/MAC CE)), cell switching indication information, and information related to cell switching may be interchangeably interpreted.

The following embodiments may be applied when an RACH procedure per TRP (or per serving cell/additional cell/non-serving cell) is configured/supported. Alternatively, the following embodiments may be applied when a timing advance/timing advance group per TRP (or per serving cell/additional cell/non-serving cell) is configured/supported.

The following description may be applied in the inter-cell mobility (for example, L1/L2 inter cell mobility) or may be applied in communication control other than inter-cell mobility (for example, intra-cell mobility (L1/L2 intra cell mobility)). The L1/L2 inter-cell mobility may be interchangeably interpreted as at least one of cell switching, cell switch, and cell change.

### Radio Communication Method

### First Embodiment

A first embodiment relates to the applying of the reference cell for the TA derivation in the L1/L2 inter-cell mobility.

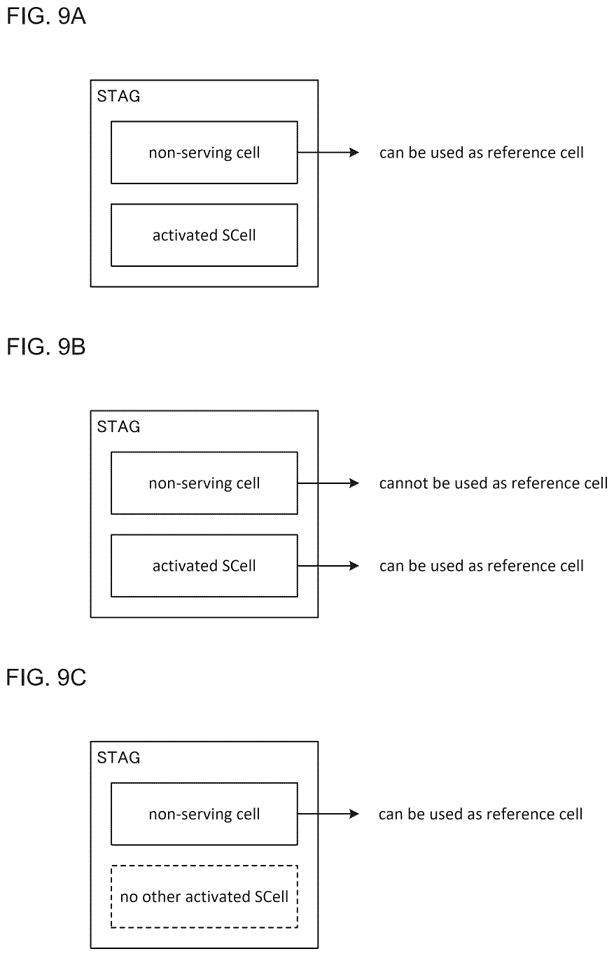

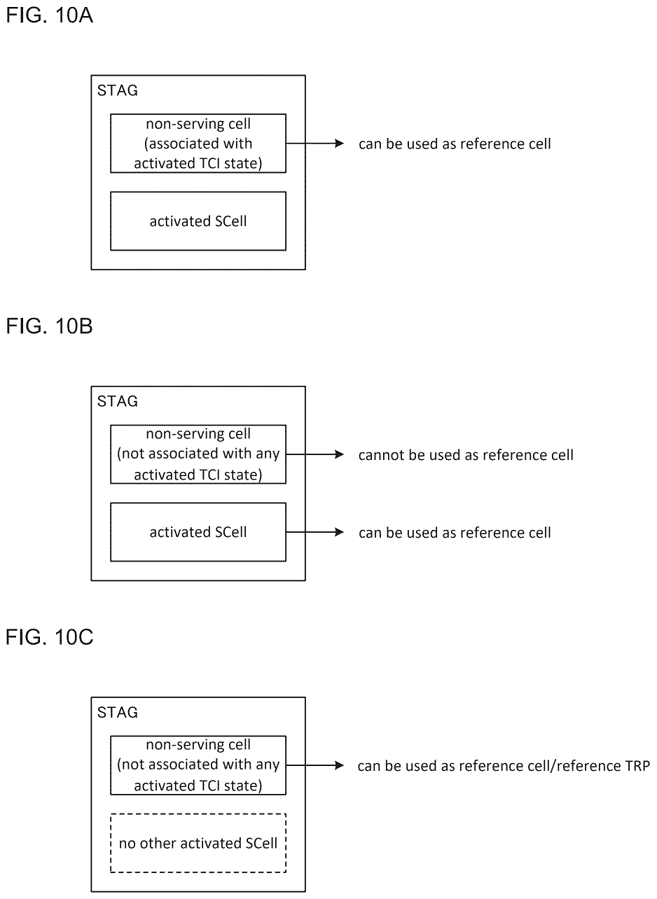

In the L1/L2 inter-cell mobility, when a candidate cell as the non-serving cell is included in the STAG, the UE may determine the reference cell for the TA derivation based on at least one of options below. FIGS. 9A to 9C and FIGS. 10A to 10C are diagrams to show examples of applying the reference cell according to the first embodiment.

### Option 1

The UE can use (apply) the non-serving cell as the reference cell in the STAG whether the non-serving cell is or is not associated with the activated TCI state (which may be referred to as the active TCI state), (see FIG. 9A).

### Option 2

The UE cannot use the non-serving cell as the reference cell in the STAG whether the non-serving cell is or is not associated with the activated TCI state (see FIG. 9B). In this case, the UE can use the activated SCell as the reference cell in the STAG (see FIG. 9B).

### Option 3

When no other activated SCell is present in the STAG, the UE cannot use the non-serving cell as the reference cell in the STAG whether the non-serving cell is or is not associated with the activated TCI state (see FIG. 9C).

### Option 4

The UE can use the non-serving cell as the reference cell in the STAG when the non-serving cell is associated with the activated TCI state (see FIG. 10A).

### Option 4-1

The UE cannot use the non-serving cell as the reference cell in the STAG when the non-serving cell is not associated with any activated ICI state (see FIG. 10B). In this case, the UE can use the activated SCell as the reference cell in the STAG (see FIG. 10B).

### Option 4-2

The UE can use the non-serving cell as the reference cell in the STAG when the non-serving cell is not associated with any activated TCI state, (only) when no other activated SCell is present in the STAG (see FIG. 10C).

According to the first embodiment described above, the UE can appropriately determine the reference cell for the TA derivation in the L1/L2 inter-cell mobility.

### Second Embodiment

A second embodiment relates to the applying of the reference cell for the TA derivation in the case of the intra-cell multi-TRP.

### Embodiment 2-1

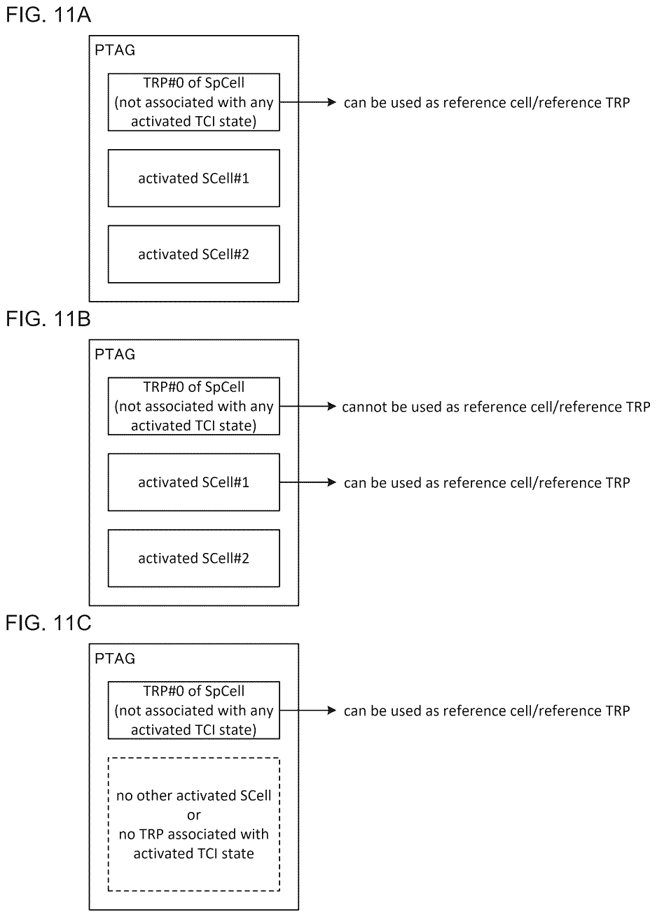

Embodiment 2-1 particularly describes a case where the TRP of the SpCell is included in the PTAG. The UE may determine the reference cell for the TA derivation based on at least one of options below. FIGS. 11A to 11C are diagrams to show examples of applying the reference cell according to the second embodiment (embodiment 2-1).

### Option 1

Even when TRP #0 of the SpCell is included in the PTAG, and relevant TRP #0 is not associated with any activated TCI state, the UE can use the SpCell/TRP #0 as the reference cell/reference TRP in the PTAG (see FIG. 11A).

### Option 2

When TRP #0 of the SpCell is included in the PTAG, when relevant TRP #0 is associated with the activated TCI state, the UE can use the SpCell/TRP #0 as the reference cell/reference TRP in the PTAG.

### Option 2-1

When TRP #0 of the SpCell is included in the PTAG, and relevant TRP #0 is not associated with any activated TCI state, the UE cannot use the SpCell/TRP #0 as the reference cell/reference TRP in the PTAG (see FIG. 11B). In this case, the UE can use the activated SCell (for example, SCell #1) as the reference cell (see FIG. 11B). Alternatively, the UE can use a TRP associated with the activated TCI state in the activated SCell as the reference TRP.

### Option 2-2

When TRP #0 of the SpCell is included in the PTAG, and relevant TRP #0 is not associated with any activated TCI state, and (only) when no other activated SCell is present/no TRP associated with the activated TCI state is present in the PTAG, the UE can use the SpCell/TRP #0 as the reference cell/reference TRP in the PTAG (see FIG. 11C).

### Embodiment 2-2

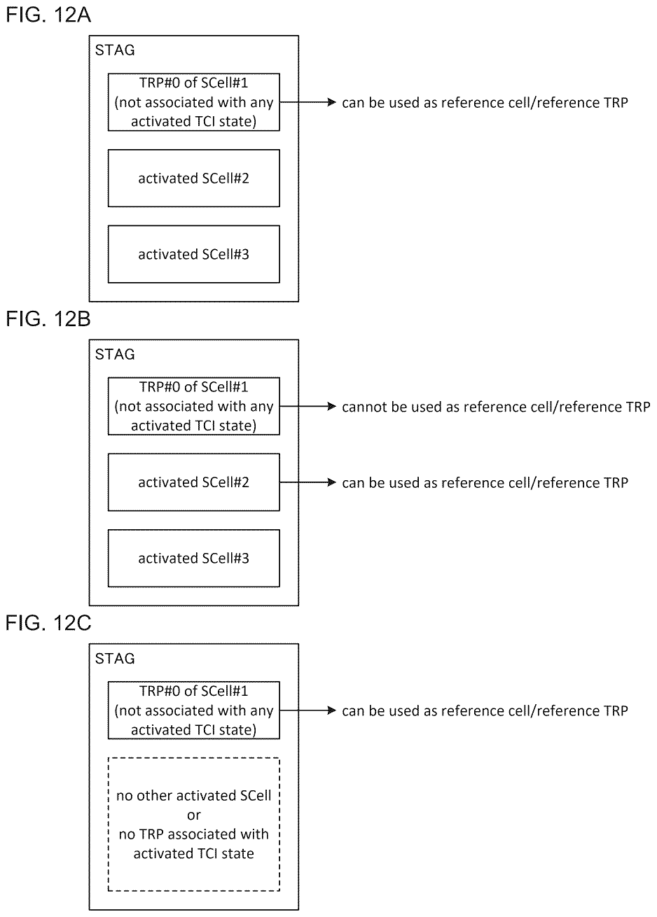

Embodiment 2-2 particularly describes a case where the TRP of the SCell is included in the STAG. The UE may determine the reference cell for the TA derivation based on at least one of options below. FIGS. 12A to 12C are diagrams to show examples of applying the reference cell according to the second embodiment (embodiment 2-2).

### Option 1

Even when the SCell #1 TRP #0 is included in the STAG, and relevant TRP #0 is not associated with any activated TCI state, the UE can use relevant SCell #1/TRP #0 as the reference cell/reference TRP in the STAG (see FIG. 12A).

### Option 2

When TRP #0 of SCell #1 is included in the STAG, and relevant TRP #0 is associated with the activated TCI state, the UE can use relevant SCell #1/TRP #0 as the reference cell/reference TRP in the STAG.

### Option 2-1

When TRP #0 of SCell #1 is included in the STAG, and relevant TRP #0 is not associated with any activated TCI state, the UE cannot use relevant SCell #1/TRP #0 as the reference cell/reference TRP in the STAG (see FIG. 12B). In this case, the UE can use the activated SCell (for example, SCell #2) as the reference cell (see FIG. 12B). Alternatively, the UE can use a TRP associated with the activated TCI state in the activated SCell as the reference TRP.

### Option 2-2

When TRP #0 of SCell #1 is included in the STAG, and relevant TRP #0 is not associated with any activated TCI state, and (only) when no other activated SCell is present/no TRP associated with the activated TCI state is present in the STAG, the UE can use relevant SCell #1/TRP #0 as the reference cell/reference TRP in the STAG (see FIG. 12C).

According to the second embodiment described above, the UE can appropriately determine the reference cell for the TA derivation in the case of the intra-cell multi-TRP.

### Third Embodiment

A third embodiment relates to the applying of the reference cell for the TA derivation in the case of the inter-cell multi-TRP.

### Embodiment 3-1

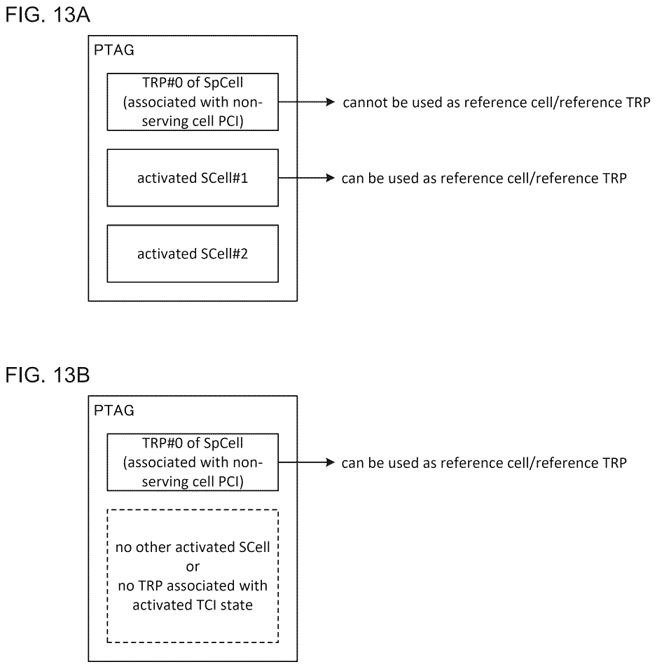

Embodiment 3-1 particularly describes a case where the TRP of the SpCell is included in the PTAG. The UE may determine the reference cell for the TA derivation based on at least one of options below. FIGS. 13A and 13B are diagrams to show examples of applying the reference cell according to the third embodiment (embodiment 3-1).

### Option 1

When the TRP is associated with the PCI of the serving cell, the UE may apply the options of embodiment 2-1 described above.

### Option 2

When the TRP is associated with the PCI of the non-serving cell, the UE may apply the options of embodiment 2-1 described above. Alternatively, the UE can apply options 3 and 4 below.

### Option 3

When TRP #0 is associated with the PCI of the non-serving cell, whether relevant TRP #0 is or is not associated with the activated TCI state, the UE cannot use the SpCell/TRP #0 as the reference cell/reference TRP in the PTAG (see FIG. 13A), In this case, the UE can use the activated SCell (for example, SCell #1) as the reference cell (see FIG. 13A). Alternatively, the UE can use a TRP associated with the activated TCI state in the activated SCell as the reference TRP.

### Option 4

When TRP #0 is associated with the PCI of the non-serving cell, whether relevant TRP #0 is or is not associated the activated ICI state, and (only) when no other activated SCell is present/no TRP associated with the activated ICI state is present in the PTAG, the UE can use the SpCell/TRP #0 as the reference cell/reference TRP in the PTAG (see FIG. 13B).

### Embodiment 3-2

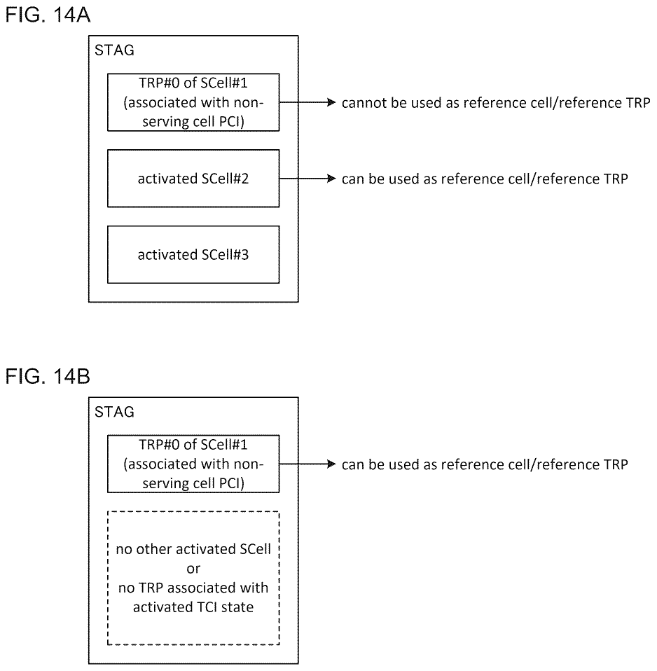

Embodiment 3-2 particularly describes a case where the TRP of the SCell is included in the STAG. The UE may determine the reference cell for the TA derivation based on at least one of options below. FIGS. 14A and 14B are diagrams to show examples of applying the reference cell according to the third embodiment (embodiment 3-2).

### Option 1

When the TRP is associated with the PCI of the serving cell, the UE may apply the options of embodiment 2-2 described above.

### Option 2

When the TRP is associated with the PCI of the non-serving cell, the UE may apply the options of embodiment 2-2 described above. Alternatively, the UE can apply options 3 and 4 below.

### Option 3

When TRP #0 of SCell #1 is associated with the PCI of the non-serving cell, whether relevant TRP #0 is or is not associated with the activated ICI state, the UE cannot use relevant SCell #1/TRP #0 as the reference cell/reference TRP in the STAG (see FIG. 14A), In this case, the UE can use the activated SCell (for example, SCell #2) as the reference cell (see FIG. 14A). Alternatively, the UE can use a TRP associated with the activated TCI state in the activated SCell as the reference TRP.

### Option 4

When TRP #0 of SCell #1 is associated with the PCI of the non-serving cell, whether relevant TRP #0 is or is not associated the activated TCI state, and (only) when no other activated SCell is present/no TRP associated with the activated TCI state is present in the STAG, the UE can use relevant SCell #1/TRP #0 as the reference cell/reference TRP in the STAG (see FIG. 14B).

According to the third embodiment described above, the UE can appropriately determine the reference cell for the TA derivation in the case of the inter-cell multi-TRP.

### Fourth Embodiment

A fourth embodiment relates to enhancement of the reference cell for the TA derivation in the L1/L2 inter-cell mobility and the intra-cell/inter-cell multi-TRP mobility.

### Embodiment 4-1

In the serving cell/non-serving cell/candidate cell in the PTAG, the UE may use the SpCell as the reference cell to derive the UE transmission timing (TA) for the cell in the PTAG, In the serving cell/non-serving cell/candidate cell in the STAG, the UE may use any of a plurality of activated SCells as the reference cell to derive the UE transmission timing (TA) for the cell in the STAG. UE initial transmission timing accuracy and gradual timing adjustment requirements may be defined in the specifications.

### Embodiment 4-2

When the activated SCell is not present in the STAG, the UE may determine the reference cell for the TA derivation based on at least one of options below.

### Option 1

The UE can use, as the reference cell, a deactive SCell configured to be the candidate cell for the L1/L2 inter-cell mobility.

### Option 2

The UE can use, as the reference cell, a non-serving cell configured to be the candidate cell for the L1/L2 inter-cell mobility.

### Option 3

When performing DL synchronization/UL synchronization with the deactive SCell/non-serving cell in option 1/option 2, the UE can use the relevant cell as the reference cell.

### Option 4

When there is the active TCI state associated with the deactive SCell/non-serving cell in option 1/option 2, the UE can use the relevant cell as the reference cell.

### Option 5

When performing CSI/L1-RSRP/L1-SINR measurement on the deactive SCell/non-serving cell in option 1/option 2, the UE can use the relevant cell as the reference cell.

### Option 6

When triggering the RACH procedure or receiving the PDCCH order triggering the RACH procedure for the deactive SCell/non-serving cell in option 1/option 2, the UE can use the relevant cell as the reference cell.

### Option 7

The UE may perform the UL fame transmission at an TA (Timing Advance) before the corresponding DL reception from the reference cell (the first detected path in time)” in each of the serving cell/non-serving cell/candidate cell. This may mean that a certain cell does not reference the DL frames for other cells.

### Variations

Priorities may be defined in the types of the cells of options 1 to 7 described above (active/deactive SCell, non-serving cell, cell with/without DL synchronization/UL synchronization, cell with/without active TCI state, cell with/without measurement, call with/without RACH triggering, and the like). For example, when a cell having a higher priority is not present in the STAG, the UE may use a cell having a lower priority as the reference cell in the STAG.

### Embodiment 4-3

When any cell in the TAG is not activated, and when any TRP in the TAG is not associated with the activated TCI state, the UE may not be required to maintain the TA for the UL transmission in the TAG.

According to the fourth embodiment described above, the UE can appropriately determine the reference cell for the TA derivation in the L1/L2 inter-cell mobility and the intra-cell/inter-cell multi-TRP mobility.

### Supplements

### Notification of Information to UE

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

### Notification of Information from UE

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
supporting a specific processing/operation/control/information for at least one of the embodiments described above.
supporting the L1/L2 intra-cell mobility/L1/L2 inter-cell mobility.
supporting the TA per TRP in the intra-cell/inter-cell multi-TRP.
supporting the configuration of the intra-cell multi-TRP/inter-cell multi-TRP for the serving cell/non-serving cell.
supporting the frame timing change of the reference cell.

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating that a random access procedure/PRACH transmission without RAR monitoring is enabled, any RRC parameter for a specific release (for example, Rel. 18/19), or the like.

When the UE does not support at least one of the specific UE capabilities above or is not configured with the specific information, Rel-15/16 operation may be applied, for example.

### Supplementary Notes

Regarding one embodiment (the first embodiment) of the present disclosure, the following supplementary notes of the invention will be given.

### Supplementary Note 1

A terminal including:
a receiving section that receives cell switching indication information in inter-cell mobility; and
a control section that determines a timing advance (TA) applied to UL transmission, based on the cell switching indication information, wherein
the control section determines a reference cell for deriving the TA, based on whether a candidate cell is included in a timing advance group (TAG).

### Supplementary Note 2

The terminal according to supplementary note 1, wherein when the candidate cell is included in the TAG, the control section applies the candidate cell as the reference cell in the TAG.

### Supplementary Note 3

The terminal according to supplementary note 1 or 2, wherein when the candidate cell is not associated with an active transmission configuration indication (ICI) state, the control section applies an activated secondary cell (SCell) or the candidate cell as the reference cell in the TAG.

### Supplementary Note 4

The terminal according to any one of supplementary notes 1 to 3, wherein when the candidate cell is included in the TAG, the candidate cell is not associated with an active transmission configuration indication (TCI) state, and an activated secondary cell (SCell) is not present in the TAG, the control section applies the candidate cell as the reference cell in the TAG

### Supplementary Notes

Regarding one embodiment (the second or third embodiments) of the present disclosure, the following supplementary notes of the invention will be given.

### Supplementary Note 1

A terminal including:
a receiving section that receives cell switching indication information in intra-cell or inter-cell mobility supporting a plurality of transmission/reception points (TRPs); and
a control section that determines a timing advance (TA) applied to UL transmission, based on the cell switching indication information, wherein
the control section determines a reference cell and a reference TRP for deriving the TA, based on whether a TRP of a specific cell is included in a timing advance group (TAG).

### Supplementary Note 2

The terminal according to supplementary note 1, wherein when the TRP of the specific cell is included in the TAG, the control section applies the specific cell as the reference cell in the TAG, or applies the TRP as the reference TRP in the TAG.

### Supplementary Note 3

The terminal according to supplementary note 1 or 2, wherein when the TRP is not associated with an active transmission configuration indication (TCI) state, the control section applies an activated secondary cell (SCell) as the reference cell in the TAG, or applies another TRP associated with an activated TCI state in the SCell as the reference TRP.

### Supplementary Note 4

The terminal according to any one of supplementary notes 1 to 3, wherein when the TRP of the specific cell is included in the TAG, the TRP is not associated with an active transmission configuration indication (TCI) state, and an activated secondary cell (SCell) is not present in the TAG, the control section applies the specific cell as the reference cell in the TAG, or applies the TRP as the reference TRP in the TAG.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

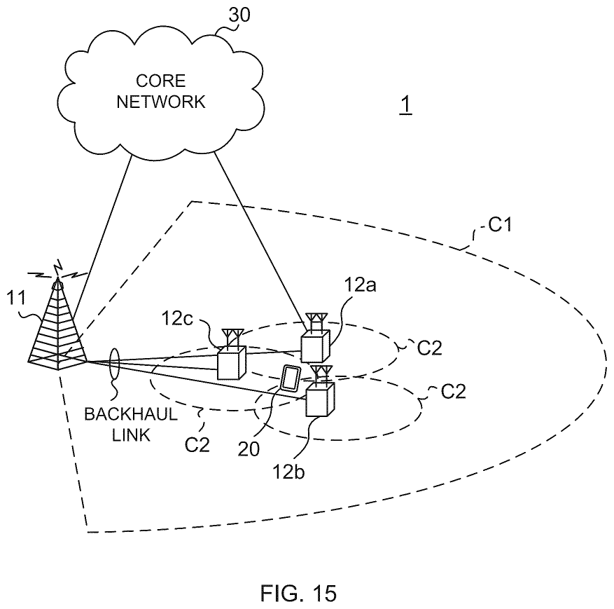

FIG. 15 is a diagram to show an example of a schematic structure of the radio communication system according to one embodiment. The radio communication system 1 (which may be referred to simply as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (qNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above −24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs) such as User Plane Function (UPF), Access and Mobility management Function (AMF), Session Management Function (SMF), Unified Data Management (UDM), Application Function (AF), Data Network (DN), Location Management Function (LMF), and operation, administration and maintenance (Management) (CAM), for example. Note that plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DET-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

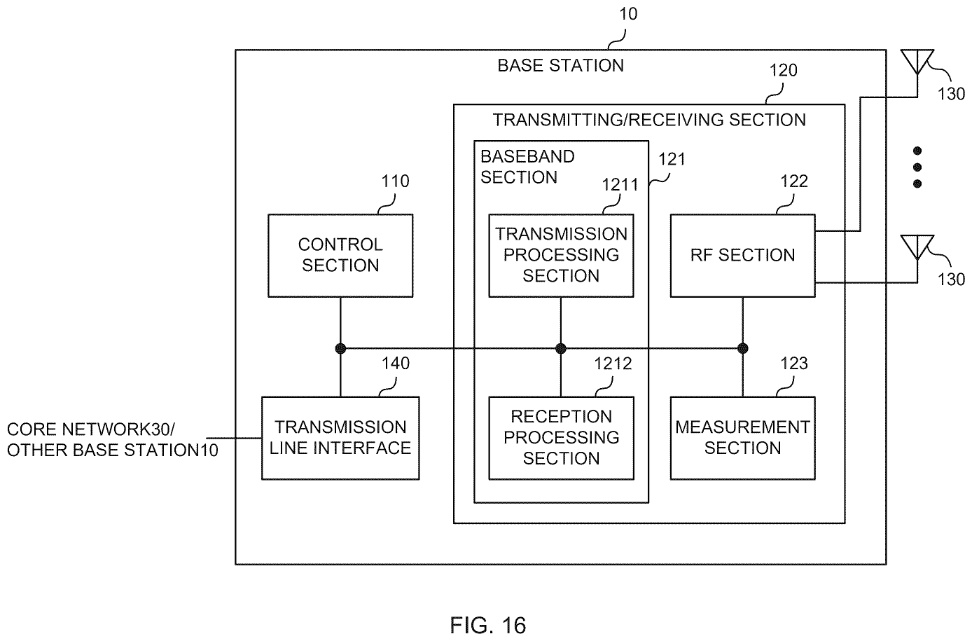

FIG. 16 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (for example, a network node that provides an NF) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit cell switching indication information in inter-cell mobility. The transmitting/receiving section 120 may apply a timing advance (TA) determined based on the cell switching indication information to receive a UL signal transmitted from a terminal. A reference cell for deriving the TA may be determined based on whether a candidate cell is included in a timing advance group (TAG).

The transmitting/receiving section 120 may transmit cell switching indication information in intra-cell or inter-cell mobility supporting a plurality of transmission/reception points (TRPs). The transmitting/receiving section 120 may apply a timing advance (TA) determined based on the cell switching indication information to receive a UL signal transmitted from a terminal. A reference cell or a reference TRP for deriving the TA may be determined based on whether a TRP of a specific cell is included in a timing advance group (TAG).

### User Terminal

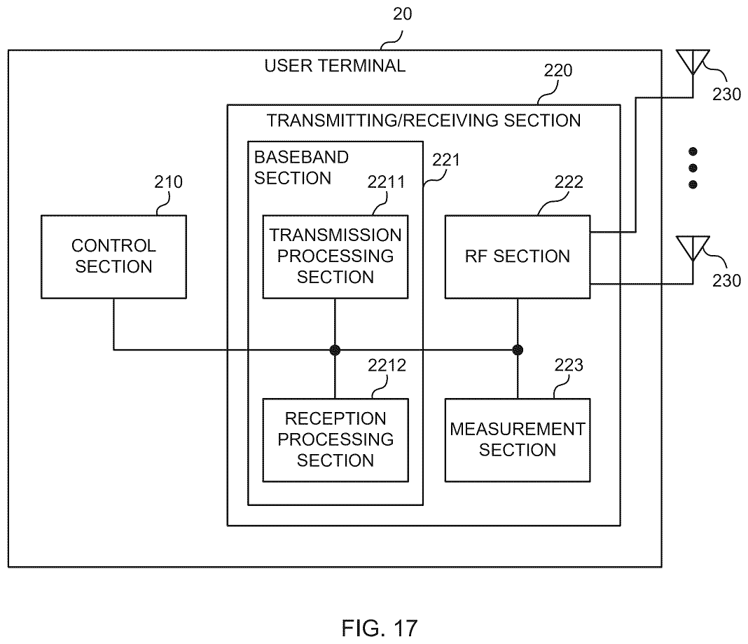

FIG. 17 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DET processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DET-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI calculation based on for a resource for channel measurement. The resource for channel measurement may be, for example, a non zero power (NZP) CSI-RS resource. The measurement section 223 may derive interference measurement for CSI calculation based on a resource for interference measurement. The resource for interference measurement may be at least one of a NZP CSI-RS resource for interference measurement, a CSI-interference measurement (IM) resource, and the like. Note that the CSI-IM may be referred to as a CSI-interference management (IM), or may be interchangeably interpreted as a zero power (ZP) CSI-RS. Note that a CSI-RS, a NZP CSI-RS, a ZP CSI-RS, a CSI-IM, a CSI-SSB, and the like may be interchangeably interpreted in the present disclosure.

Note that the transmitting section and the receiving section of the user terminal 20 in the present disclosure may be constituted with at least one of the transmitting/receiving section 220 and the transmitting/receiving antennas 230.

The transmitting/receiving section 220 may receive cell switching indication information in inter-cell mobility. The transmitting/receiving section 220 may transmit a random access channel (PRACH) based on a first PDCCH order. The MAC CE may include at least one of a field for the cell switching and a field for the TA. The MAC CE may include at least one of a field for the TA adjustment and a field for an absolute TA command (TAC). The MAC CE may include a field indicating a presence of a field for a TA indication.

The control section 210 may determine a timing advance (TA) applied to UL transmission, based on the cell switching indication information. The control section 210 may determine a reference cell for deriving the TA, based on whether a candidate cell is included in a timing advance group (TAG). When the candidate cell is included in the TAG, the control section 210 may apply the candidate cell as the reference cell in the TAG. When the candidate cell is not associated with an active transmission configuration indication (ICI) state, the control section 210 may apply an activated secondary cell (SCell) or the candidate cell as the reference cell in the TAG. When the candidate cell is included in the TAG, the candidate cell is not associated with an active transmission configuration indication (ICI) state, and an activated secondary cell (SCell) is not present in the TAG, the control section 210 may apply the candidate cell as the reference cell in the TAG

The transmitting/receiving section 220 may receive cell switching indication information in intra-cell or inter-cell mobility supporting a plurality of transmission/reception points (TRPs).

The control section 210 may determine a timing advance (TA) applied to UL transmission, based on the cell switching indication information. When the TRP of the specific cell is included in the TAG, the control section 210 may apply the specific cell as the reference cell in the TAG, or apply the TRP as the reference TRP in the TAG. When the TRP is not associated with an active transmission configuration indication (TCI) state, the control section 210 may apply an activated secondary cell (SCell) as the reference cell in the TAG, or apply another TRP associated with an activated TCI state in the SCell as the reference TRP. When the TRP of the specific cell is included in the TAG, the TRP is not associated with an active transmission configuration indication (TCI) state, and an activated secondary cell (SCell) is not present in the TAG, the control section 210 may apply the specific cell as the reference cell in the TAG, or apply the TRP as the reference TRP in the TAG.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

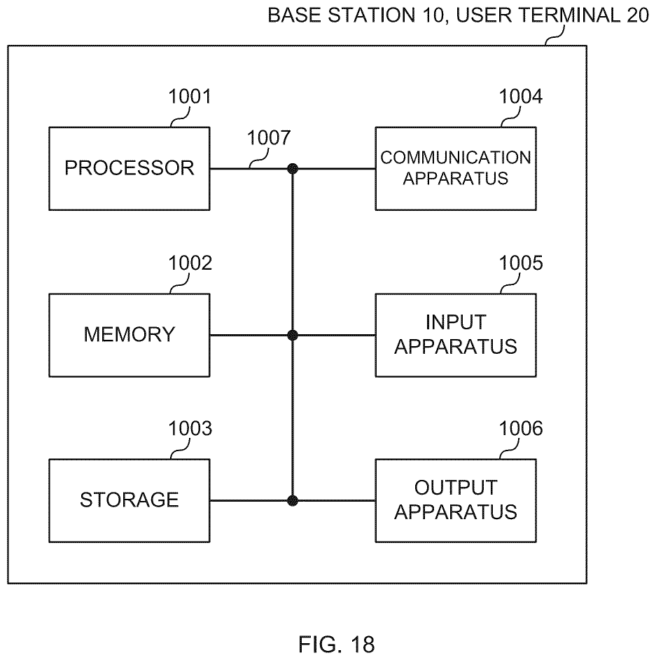

For example, a base station, a user terminal, and so on according to one embodiment of the present disclosure may function as a computer that executes the processes of the radio communication method of the present disclosure. FIG. 18 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part of all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a VE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CES).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software” “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer”, “the number of layers”, a “rank”, a “resource”, a “resource set”, a “beam”, a “beam width”, a “beam angular degree”, an “antenna”, an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e.g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)”, a “unified TCI state”, a “common TCI state”, a “joint TCI state”, and the like may be used interchangeably.

In the present disclosure, “QCL”, “QCL assumption”, “QCL relationship”, “QCL type information”, “QCL property/properties”, “specific QCL type (e.g., type A, type D) property”, “specific QCL type (e. g., type A, type D)”, and the like may be used interchangeably.

In the present disclosure, an “index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

A spatial relation information identifier (ID) (TCI state ID) and spatial relation information (TCI state) may be interchangeably used. “Spatial relation information (TCI state)” may be used interchangeably with “a set of spatial relation information (ICI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station,” a “NodeB”, an “ENB (eNodeB)”, a “qNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”. “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

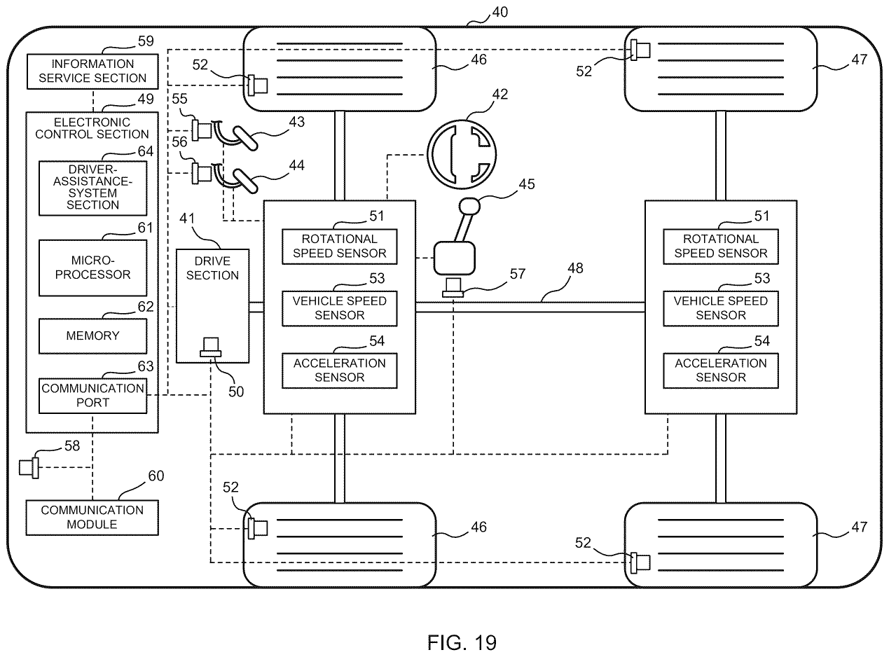

FIG. 19 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LIDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or DIE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“ . . . ” may be expressed using, for example, a that-clause, a to-infinitive, or the like) may be used interchangeably with “be expected . . . ”. “Does not expect . . . ” may be used interchangeably with “be not expected . . . ”. Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, =“B during/while A”, “B before A”, “B (at the same time as)/on A”, “B after A”, “B since A”, “B until A”, and the like may be used interchangeably. Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e. g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

This application is based on and claims priority to Japanese Patent Application No. 2023-28459, filed on Feb. 27, 2023, the contents of which are incorporated herein by reference in their entirety.

1-6. (canceled)

7. A terminal comprising:
a processor that, when a transmission and reception point (TRP) of a secondary cell (SCell) is included in a secondary timing advance group (STAG), applies the TRP as a reference TRP to derive a timing for uplink (UL) transmission in the STAG in both cases where the TRP is associated with an activated transmission configuration indication (TCI) state and where the TRP is not associated with the activated TCI state; and
a transmitter that performs the UL transmission by applying the timing.

8. A radio communication method for a terminal, comprising:
when a transmission and reception point (TRP) of a secondary cell (SCell) is included in a secondary timing advance group (STAG), applying the TRP as a reference TRP to derive a timing for uplink (UL) transmission in the STAG in both cases where the TRP is associated with an activated transmission configuration indication (TCI) state and where the TRP is not associated with the activated TCI state; and
performing the UL transmission by applying the timing.

9. A base station comprising:
a processor that, when a transmission and reception point (TRP) of a secondary cell (SCell) is included in a secondary timing advance group (STAG), determines that the TRP is a reference TRP to derive a timing for uplink (UL) transmission in the STAG in both cases where the TRP is associated with an activated transmission configuration indication (TCI) state and where the TRP is not associated with the activated TCI state; and
a receiver that receives the UL transmission by applying the timing.

10. A system comprising a terminal and a base station, wherein the terminal comprises:
a processor that, when a transmission and reception point (TRP) of a secondary cell (SCell) is included in a secondary timing advance group (STAG), applies the TRP as a reference TRP to derive a timing for uplink (UL) transmission in the STAG in both cases where the TRP is associated with an activated transmission configuration indication (TCI) state and where the TRP is not associated with the activated TCI state; and
a transmitter that performs the UL transmission by applying the timing, and the base station comprises:
a receiver that receives the UL transmission.
